(19) United States
(12) Patent Application Publication
(10) Pub. No.: US 2011/0161342 A1
(43) Pub. Date: Jun. 30, 2011

(54) BUSINESS OBJECT NODE ACCESS MANAGEMENT FOR SEARCH SERVICES IN A SERVICE-ORIENTED ARCHITECTURE

(76) Inventors: Lambert Boskamp, Dossenheim (DE); Cristina Buchholz, Reilingen (DE); Peter Dell, Lebach (DE); Wolfgang Koch, Ostringen--Odenheim (DE); Markus Viol, Walldorf (DE); Jens Weiler, Weingarten (DE)

(21) Appl. No.: 12/647,755

(22) Filed: Dec. 28, 2009

(51) Int. Cl. G06F 17/30

(52) U.S. Cl. 707/769; 707/E17.014; 707/E17.005; 707/781

(57) ABSTRACT

A system may include a database comprising stored data and a business process platform including business object metadata defining business objects representing the stored data. The business process platform may receive a query from a user to retrieve data from a first business object node of a business object, the business object representing stored data, determine whether the user is authorized to traverse all associations of a SELECT list of the query, determine whether the user is authorized to traverse all associations of a WHERE clause of the query, determine whether the user is authorized to retrieve any instances of each business object node of column specifications of the SELECT list of the query, and, if the determinations are affirmative, executing the query to retrieve a first result set.

### FIELD

Some embodiments relate to a service-oriented architecture to provide search services. More specifically, some embodiments relate to providing execution of business object-based queries using node-level access management services.

### BACKGROUND

Business data is typically stored within physical tables of a database. The database may comprise a relational database such as SAP MaxDB, Oracle, Microsoft SQL Server, IBM DB2, Teradata and the like. Alternatively, the database could be a multi-dimensional database, an eXtendable Markup Language document, or any other structured data storage system. The physical tables may be distributed among several relational databases, dimensional databases, and/or other data sources.

The structures of and relationships between the physical database tables are complex. Business objects are conventionally used to shield developers and end-users from these complexities. A business object is a software model including nodes to encapsulate related data and methods, and optionally an access control list to enable per instance access control of the business object.

A business object may represent a business entity, such as a customer, partner, sales order, product, store, time, etc., represented in the data of a data source. Each instance of a business object represents a particular instance of the entity represented by the business object. An instance of a sales order business object may, for example, provide a mapping to the underlying tables storing data associated with a particular sales order.

A developer may create a logical view of stored data based on business objects representing the stored data. A user may then access the logical view to view the stored data. Due to various business concerns (e.g., security, confidentiality, privacy), it is often necessary to restrict a user's access to all or a portion of a logical view. Conventionally, a developer of a view includes security restrictions within the view. The security restrictions may prohibit a user from viewing certain rows/columns of the tables on which the view is based.

More recent systems support free-defined queries directly on business objects. Such a query may be created using Business Query Language (BQL) or as a Service Adaptation Description Language (SADL) document, which is then parsed, normalized to a common format, and executed by an interpreter. The results of a free-defined query must be secured based on the user to whom the results will be presented.

Some current systems allow a developer to define access control lists for a specific business object instance. An access control list specifies the access group that a business object instance belongs to, from an authorization point of view. Administrators, on the other hand, can then allow users to perform the authorizations of a role only on those business object instances of certain access groups. The aforementioned systems for presenting logical views and processing free-defined queries are unable to efficiently leverage such instance-level access restrictions.

### BRIEF DESCRIPTION OF THE DRAWINGS

FIG. 1 is a block diagram of a system according to some embodiments.

FIG. 2 is a flow diagram of a process according to some embodiments.

FIG. 3 is a logical data model according to some embodiments.

FIG. 4 is a modeling pattern for Access Control List destinations according to some embodiments.

FIG. 5 is a modeling pattern for Access Control List destinations according to some embodiments.

FIG. 6 is a modeling pattern for Access Control List destinations according to some embodiments.

FIG. 7 is a block diagram of a system according to some embodiments.

FIGS. 8a and 8b comprise a flow diagram of a process according to some embodiments.

FIG. 9 is a detailed block diagram of a system according to some embodiments.

FIG. 10 is a sequence diagram corresponding to FIG. 2 according to some embodiments.

FIG. 11 is a sequence diagram corresponding to FIGS. 8a and 8b according to some embodiments.

### DETAILED DESCRIPTION

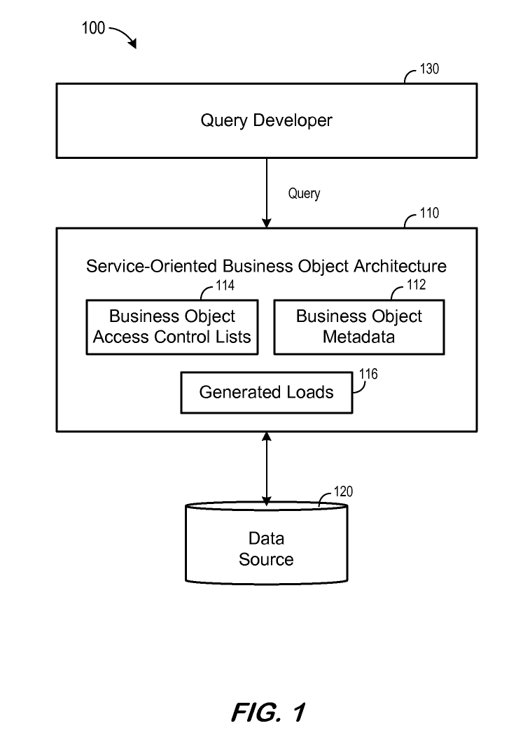

FIG. 1 is a block diagram of system 100 according to some embodiments. System 100 includes service-oriented business object architecture 110, data source 120, and query developer 130. According to some embodiments, system 100 may generate a load based on a query on business objects nodes of architecture 110. As will be described below, such a load is thereafter executable to retrieve associated data from data source 120.

Architecture 110 (e.g., SAP Business ByDesign®, Salesforce) may provide services (e.g., Web services) according to some embodiments. More specifically, architecture 110 may provide data security and data distribution functions. Architecture 110 may also include business logic for providing business functions based at least in part on the data of data source 120.

Architecture 110 includes business object metadata 112 to define business objects as is known in the art. Business object Access Control Lists (ACLs) 114 include entries which specify a particular instance of a business object root node, representing the whole business object instance, and an access group which represents a logical group of business object instances from an authorization point of view. Each root node of each business object defined by business object metadata 112 may be associated with one of ACLs 114.

Generated loads 116 may be stored in a cache or in a persistent storage for later use by architecture 110. In particular, a load 116 is generated based on a query created by a developer (e.g., a provider of architecture 110, a business partner of the provider, a key user of a purchaser of architecture 110). The load 116 implements an execution plan to provide efficient execution of the query. Accordingly, the load 116 is used in a case that a future user requests execution of the query to retrieve data from data source 120.

Data source 120 may comprise any combination of data sources as is known in the art. The data stored in data source 120 may be received from disparate hardware and software systems, some of which are not interoperational with one another. The systems may comprise a back-end data environment employed in a business or industrial context. The data may be pushed to data source 120 and/or provided in response to queries received therefrom.

Query developer 130 represents any combination of hardware and/or software which may be used to create a query on business object nodes. Query developer 130 may access business object metadata 112 to formulate such queries. Examples of query developer 130 include, but are not limited to, a Web browser, an execution engine (e.g., JAVA, Flash, Silverlight) to execute associated code in a Web browser, and a dedicated standalone application.

FIG. 1 represents a logical architecture for describing processes according to some embodiments, and actual implementations may include more or different components arranged in other manners. The illustrated components may include other unshown elements that may be used during operation thereof, such as any suitable program code, scripts, or other functional data that is executable to interface with other elements, other applications, other data files, operating system files, and device drivers. These elements are known to those in the art, and are therefore not described in detail herein.

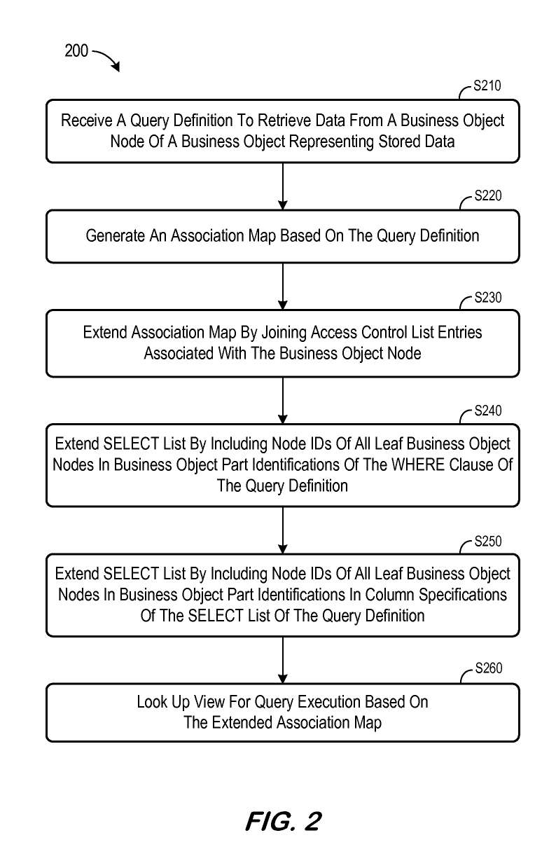

FIG. 2 is a flow diagram of process 200 according to some embodiments. Architecture 110 may execute process 200 as will be described below, but embodiments are not limited thereto. In this regard, all processes described herein may be executed by any combination of hardware and/or software. The processes may be embodied in program code stored on a tangible medium and executable by a computer to provide the functions described herein.

Initially, at S210, a query definition is received. The query definition comprises a query to receive data from one or more business object nodes of one or more business objects representing stored data. In one example, query developer 130 of system 100 generates a query one or more based on business object metadata 112 and transmits the query one or more to architecture 110. Architecture 110 receives the query definition at S210.

The query definition may describe a mapping between one or more business object nodes and a result set structure. In some embodiments, the query definition conforms to BQL or to SADL. In the latter case, the query definition comprises an SADL document.

An association map is generated based on the query definition at S220. Generation of an association map is a known process for identifying the business object nodes which need to be joined in order to create the virtual view from which the query can select data. Accordingly, S220 may comprise analyzing business object metadata 112 to identify such joins. An association map is conventionally used by a compiler to look up a suitable search plug-in for query execution. The association map and the identity of the search plug-in comprises the generated load.

Next, at S230, the association map is extended by joining ACL entries associated with the anchor business object node of the query definition. The business object node of concern at S230 is the business object node specified in the FROM clause (or equivalent syntax) of the query definition. The manner in which the association map is extended may depend on how ACL destinations are modeled in metadata 112.

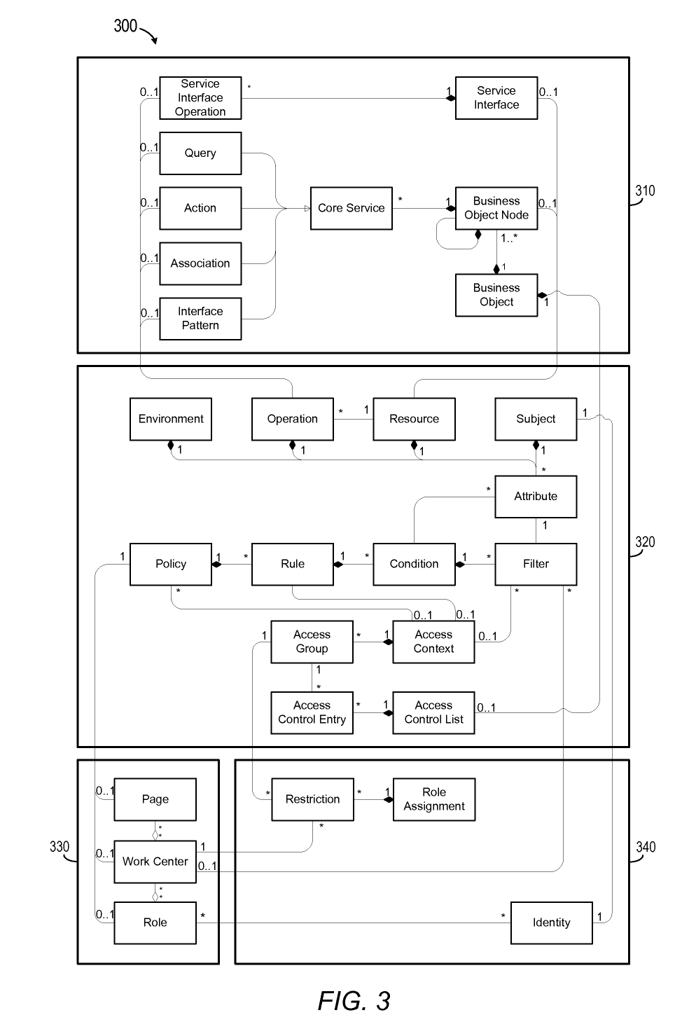

Before turning to various modeling patterns of ACL destinations, a brief discussion of a data model according to some embodiments is provided. FIG. 3 illustrates such a data model, including business object metadata 310, node access management metadata 320, user interface metadata 330 and identity management metadata 340.

The fundamental entity of node access management metadata 320 is a policy. Generally, node access management according to some embodiments allows any operation on any given business object data if and only if the union of all policies that are active in the system allow the operation. This is typically the case if the user accessing the data is assigned to a role whose policy allows the operation.

Policies contain rules, which specify conditions regarding the subject (i.e., user), operation and/or resource (i.e., business object) involved in a request, and a desired authorization decision (i.e., grant or deny) for cases where all conditions of the rule are fulfilled. A runtime authorization decision for a given request is made based on the union of all rules of all policies in the system whose conditions are all fulfilled for this request. If no rule matches the request, the implicit default rule is to deny access. If multiple rules match the request, deny rules take precedence over grant rules.

A typical rule may be semantically expressed as follows: If the identity making the request is assigned to the seller role, and the resource accessed is the root node of a sales order business object, and the operation to be performed is the core service RETRIEVE, and the ACL entries of the accessed sales order instance have an intersection with the restrictions of the user's assignment to the seller role, then grant access.

Policies exist for pages, work centers and roles. An SAP portal page is a part of the web browser window governed by exactly one business application. In standard HTML technology, an SAP portal page is similar to a frame. A work center is a collection of portal pages tailored for one job function (e.g., all portal pages required by a person performing the job of a seller).

A role is a group of work centers that can be assigned to a user (work centers can't be assigned to users directly). In some embodiments, each work center is assigned to a role with the same name by default (i.e., the default is a 1:1 relationship between work centers and roles). As there is one work center “Seller”, there is also one role “Seller”, which is assigned exactly to the work center “Seller”.

Page policies specify which operations on which resource types should be allowed for users of that page. A work center policy aggregates rules of all pages in the work center, and provides an option to make the rules specific to resource instances. Semantically, rules become specific to resource instances by restricting the containing policy to an access context. Role policies aggregate rules from work centers of that role. In the present example, roles can be assigned to users while pages and work centers cannot.

Access groups are runtime entities, representing groups of resource instances for a specific access context. At runtime, applicability of rules in a role policy can be restricted to one or more access groups by creating a restriction for a user-role assignment. Therefore, the same role can be restricted to different access groups for different users. Resource instances, on the other hand, are assigned to access groups by application logic. Access control lists are an interface that resource instances use to expose these assignments. Each access control list entry represents one assignment of a resource instance to an access group.

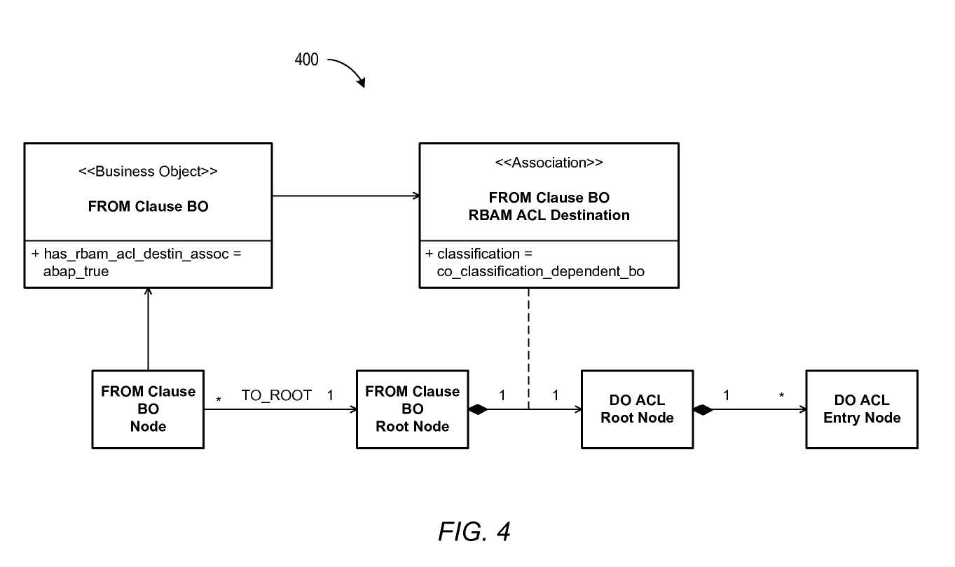

FIG. 4 illustrates dependent object ACL modeling pattern 400 according to some embodiments. A dependent object is a reusable substructure that can be included in multiple business object types. As shown, the modeler includes dependent object AccessControlList in business object metadata 112, and sets root node property “ACL Destination” to the dependent object association pointing from the business object root to the dependent object root. As a result, runtime access to the business object can be controlled at the instance level.

In the case of the FIG. 4 modeling pattern, S230 includes joining the FROM clause business object node to the FROM clause business object root node, from there to the dependent object ACL root node, and from there to the dependent object ACL Entry node.

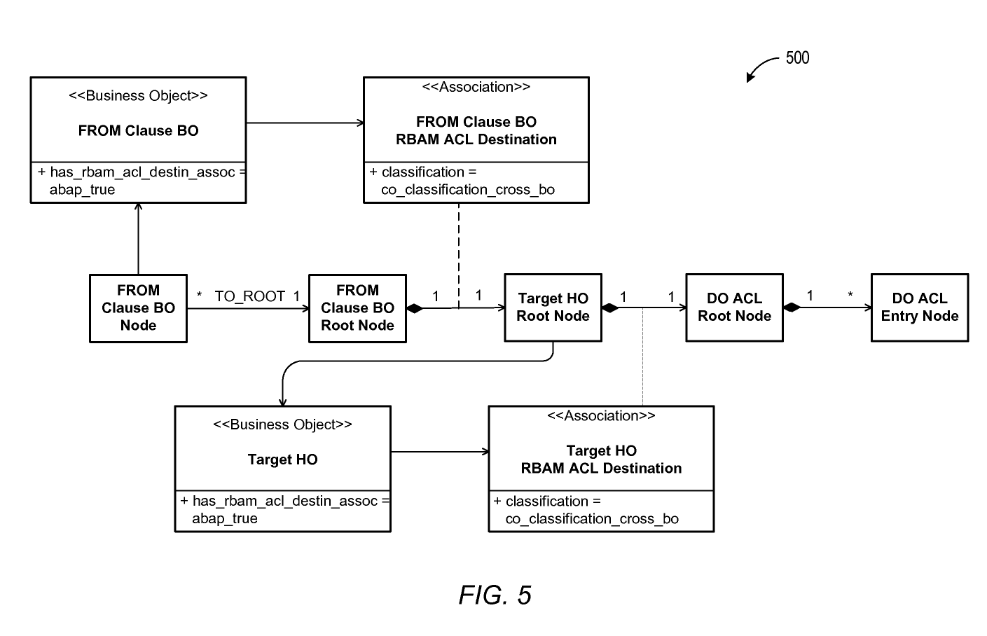

FIG. 5 illustrates cross-business object ACL modeling pattern 500 according to some embodiments. Pattern 500 models a cross-business object association from one business object type to the target Hosting Object (i.e., the business object which includes the dependent object (which is the dependent object's host)), which must in turn implement the Dependent Object ACL modeling pattern described above. Root node property “ACL Destination” is set to the cross-business object association pointing from the business object root node to the target HO root node. Modeling pattern 500 also provides control of runtime access to the business object at the instance level.

If the business object node in the query's FROM clause implements modeling pattern 500, the association map is extended at S230 by joining the FROM clause business object node to the FROM clause business object root node, from there to the target HO root node, from there to the dependent object ACL root node, and from there to the dependent object ACL entry node.

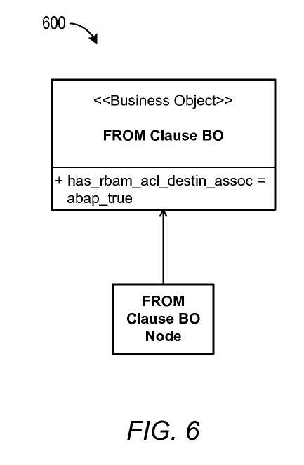

Modeling pattern 600 of FIG. 6 does not provide modeling of ACLs. Access to a business object node therefore cannot be controlled at the instance level, but only at the type and function level. If the business object node in the query's FROM clause is modeled as shown in FIG. 6, the association map is not extended at S230.

At S240, the SELECT list is extended by including node identifiers of all leaf business object nodes in business part identifications of the query's WHERE clause. As will be described below, execution of the query may require some instance-specific authorization checks which are implemented as a post-filter applied to an intermediate query result set. The node identifiers implicitly added to the SELECT list are required for these checks.

The terms “leaf business object” and “leaf business object node” as used herein refer to the name of the business object and business object node which is the source of the last (syntactically right-most) association in the business object part identification of a SELECT list or a WHERE clause.

It is noted that, if cross-BO associations are involved, the leaf business object could be a business object other than that which is at the start of the association chain. If the business object part identification does not contain any association identifier, the leaf business object and leaf business object node are identical to those aliased by the business object alias identifier.

In order to better understand the example of S240 provided below, it is noted that, according to the BQL specification, the syntax of a WHERE clause is:

```
<WhereClause> :=
  <BooleanExpression> ( and <BooleanExpression> ) *
<BooleanExpression> :=
  <BoPartIdentificaton>
  ( ( = | <> | > | < | >= | =< I LIKE )
  ( <NumberString> | <CharString> )
  | IN <ValueList>
  | IS INITIAL | IS NOT INITIAL | IS NULL | IS NOT NULL )
<BoPartIdentification> :=
  <BusinessObjectNodeAliasIdentifier>
  ( ~> <AssociationIdentifier> ) *
  ~ <Attributeldentifier>
    ( - <SubAttributeldentifier>) *
```

For example, it is assumed that the following query was received at S210:

| SELECT PR~ID | AS PRODUCT |
|---|---|
| FROM http://sap.com/xi/ESF/Product~>Root | AS PR |
| WHERE PR~>Description-Description-languageCode = ‘EN’ | |
| AND PR~>WebResource~>DetailDescription | |
| ~Description-languageCode | = ‘EN’ |

For the WHERE clause above, the SELECT list is extended at S240 by including not only the “ID” attribute of the Product˜>Root node, but also the “NODE_ID” attributes of the nodes Product˜>Description and Product˜>DetailDescription. The “NODE_ID” attribute will not be included for the node Product˜>WebResource, as this node is not a leaf of any association chain in the WHERE clause.

The SELECT list is again extended at S250. The extension includes node identifiers of all leaf business object nodes in business part identifications in column specifications of the SELECT list of the query definition. For example, according to the BQL language specification, the syntax of a SELECT list is (excerpts):

```
<SelectList> :=
  ( <Columnspecification> | <AggregationSpecification> )
  ( <ColumnSpecification> | <AggregationSpecification> ) *
<ColumnSpecification> :=
  ( DISTINCT ) ? <BoPartldentification> AS
<AliasIdentifier>
<AggregationSpecification> :=
  (COUNT | MIN | MAX | AVG | SUM ) (DISTINCT) ?
  “(” <BoPart2dentification> “)” AS <AliasIdentifier>
```

To illustrate S250 according to some embodiments, it is assumed that the following query was received at S210:

| SELECT PR~ID | AS PRODUCT |
|---|---|
| PR->WebResource~>DetailDescription | |
| ~Description-languageCode | AS LANGU |
| FROM http://sap.com/xi/ESF/Product~>Root | AS PR |

The SELECT list above will be implicitly extended to include not only the attributes aliased as “PRODUCT” and “LANGU” in the SELECT list, but also the “NODE_ID” attributes of the Product˜>Root node and the Product˜>DetailDescription node. These extensions are performed because the user will effectively retrieve data (the “ID” attribute) of Product˜>Root node instances. The user will also effectively retrieve data (the “Description-languageCode” attribute) of Product˜>DetailDescription node instances.

For the Product˜>WebResource node, the “NODE_ID” attribute will not be included because this node is not a leaf of any association chain of column specifications in the SELECT list. The result set will therefore include no data of Product->WebResource node instances.

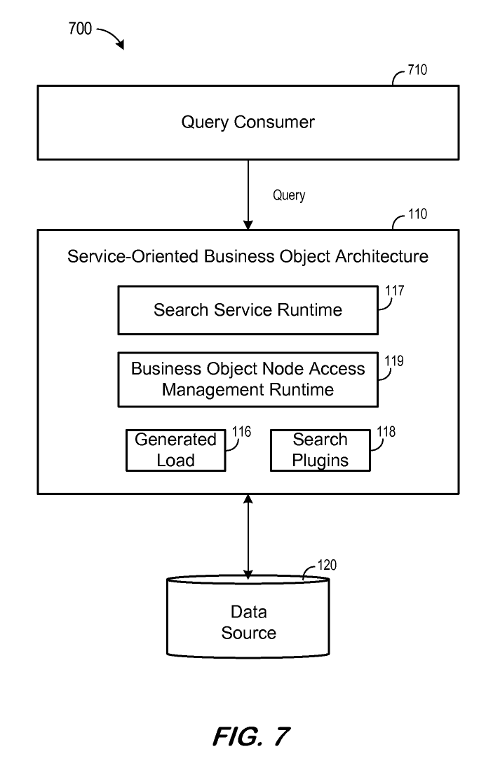

FIG. 7 is a block diagram of runtime system 700 according to some embodiments. System 700 includes service-oriented business object architecture 110 of FIG. 1, data source 120, and query consumer 710. According to some embodiments, system 110 may execute a query on business object nodes received from query consumer 710 and return a result set of data from data source 120. Generated load 116 is associated with the query and is used by architecture 110 to facilitate execution of the query.

Search service runtime 117 provides parsing, compiling and interpreting of received queries. Search service runtime 117 may support one or more types of queries, including but not limited to BQL and SADL queries. Conventionally, search service runtime uses search plugins 118 to execute a previously compiled query based on a load 116 associated with the query.

According to the some embodiments, search service runtime 117 calls functions of business object node access management runtime 119 to perform authorization checks and determine instance restrictions based on the query. If the authorization checks indicate that the user executing the query is not authorized for all parts of the result set, search service runtime 117 may modify the query based on the determined instance restrictions and filter the result set based on the determined instance restrictions.

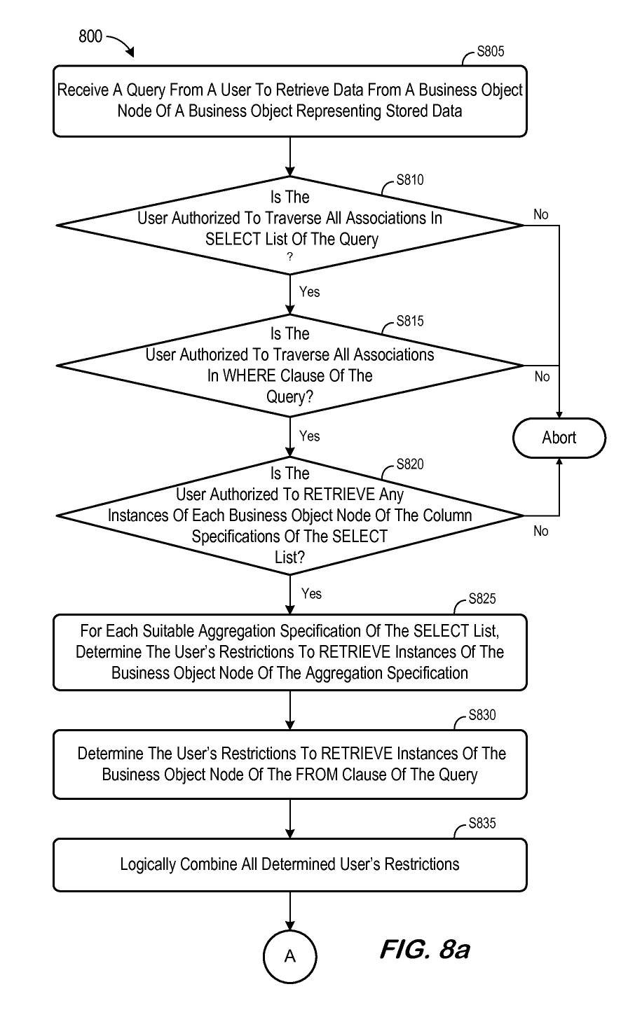

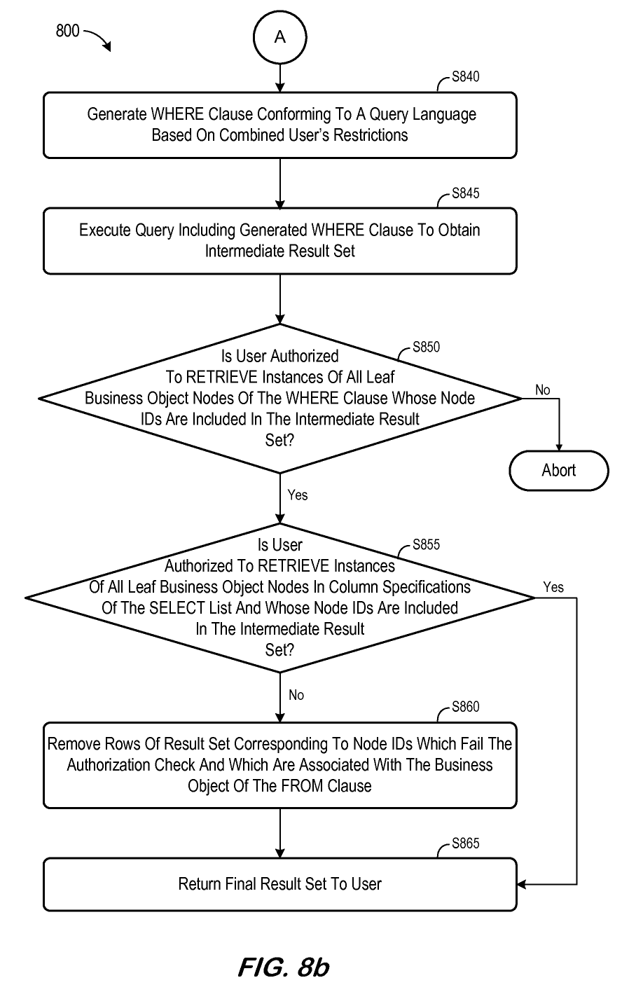

Process 800 of FIGS. 8a and 8b describes query execution according to some embodiments. A query is received from a user at S805. The query is intended to retrieve data from one or more business object nodes of one or more business objects representing stored data. It will be assumed that a load associated with the query has been previously generated, for example according to process 200.

At S810, it is determined whether the user is authorized to traverse all associations in the SELECT list of the query. This determination may be performed by calling services of business object node access management runtime 119. According to some embodiments, the call includes the following parameters:

| | |
|---|---|
| IF_USER | = <sy-uname> |
| IS_OPERATION-TYPE | = IF_RBAM_ESF_CONSTANTS=>CO OP |
| TYPE ASSOC | |
| IS_OPERATION-NAME | = <proxyname of association> |
| IF_BO-NAME | = <proxyname of business object> |
| IF_BO-NODE-NAME | = <proxyname of business object node> |

According to a specific example of S810, the following query is received:

| | | |
|---|---|---|
| SELECT | PR~ID | AS PRODUCT |
| | PR~>Description~Description-content | AS DESCR |
| FROM | http://sap.com/xi/ESF/Product~>Root | AS PR |

| | |
|---|---|
| WHERE | PR~>Description~Description-languageCode = ‘EN’ |

For the SELECT list of this query, S810 comprises determining whether the user is allowed to traverse “Description” associations, whose source BO node is Product˜>Root. The parameters of this check may include:

| | |
|---|---|
| IF_USER | = <sy-uname> |
| IS_OPERATION-TYPE | = IF_RBAM_ESF_CONSTANTS=> |

CO_OP_TYPE_ASSOC

| | |
|---|---|
| IS_OPERATION-PNAME | = |

IF_ESA_SAMPLE PRODUCT=>CO_ASSOC-ROOT-DESCRIPTION

| | |
|---|---|
| IF_BO_NAME | = IF ESA SAMPLE_ PRODUCT=>CO_BO_NAME |
| IF_BO_NODE_NAME | = IF ESA_SAMPLE_PRODUCT=>CO_BO_NODE-ROOT |

Process 800 (and execution of the query) is aborted if the determination at S810 is negative. Some embodiments provide a suitable error message to the user in a case that process 800 is aborted.

It is then determined at S815 whether the user is authorized to traverse all associations in the WHERE clause of the query. Again, this determination may be performed by calling services of business object node access management runtime 117. According to some embodiments, the call includes the parameters:

```
IF_USER = <sy-uname>
IS_OPERATION-TYPE IF_ RBAM_ESF_CONSTANTS=>CO OP TYPE
ASSOC
IS_OPERATION-PNAME <proxy name of association>
IF BO NAME
  <proxy name of association's source business object>
IF BO NODE-NAME
  <proxy name of association's source business object
node>
```

As an example of S815 according to some embodiments, the following query is considered:

| SELECT PR~ID | |
|---|---|
| AS PRODUCT | |
| PR~>Description~Description-content | |
| AS DESC | |
| PR~>WebResource~>DetailDescription~Description-content | |
| AS DETAIL_DESC | |
| FROM http://sap.com/xi/ESF/Product~>Root | AS PR |
| WHERE PR~>Description~Description-languageCode | = ‘EN’ |
| AND PR~>WebResource~>DetailDescription | |
| Description-languageCode | = ‘EN’ |

The WHERE clause of this query requires three authorization checks at S815. Specifically, checks are performed to verify that the user is authorized to traverse the associations from Product˜>Root to the Description node (Check 1), from Product˜>Root to the WebResource node (Check 2), and from the Product˜>WebResource to the Product˜>DetailDescription node (Check 3). In particular:

| | |
|---|---|
| Check 1 | |
| IF_USER = | <sy-uname> |
| IS_OPERATION-TYPE = | IF_RBAM_ESF_CONSTANTS=> |

CO_OP_TYPE_ASSOC

IS_OPERATION-PNAME =

IF_ESA_SAMPLE PRODUCT=>CO_ASSOC-ROOT-DESCRIPTION

| | |
|---|---|
| IF_BO_NAME = | IF ESA SAMPLE_ PRODUCT=>CO_BO_NAME |
| IF_BO_NODE_NAME = | IF ESA_SAMPLE_PRODUCT=>CO_BO_NODE-ROOT |
| Check 2 | |
| IF_USER = | <sy-uname> |
| IS_OPERATION-TYPE = | IF RBAM_ESF CONSTANTS=> |

CO_OP_TYPE_ASSOC

IS_OPERATION-PNAME =

IF_ESA_SAMPLE_PRODUCT=>CO_ASSOC-ROOT-WEB_RESOURCE

| | |
|---|---|
| IF_BO_NAME = | IF ESA_SAMPLE_PRODUCT=>CO_BO_NAME |
| IF_BO_NODE_NAME = | IF_ESA_SAMPLE_PRODUCT=>CO_BO_NODE-ROOT |
| Check 3 | |
| IF_USER = | <sy-uname> |
| IS_OPERATION-TYPE = | IF RBAM_ESF CONSTANTS=> |

CO_OP_TYPE_ASSOC

IS_OPERATION-PNAME =

IF_ESA_SAMPLE_PRODUCT=>CO_ASSOC-ROOT-WEB_RESOURCE-
DETAIL_DESCRIPTION

| | |
|---|---|
| IF_BO_NAME = | IF ESA_SAMPLE_PRODUCT=>CO_BO_NAME |
| IF_BO_NODE_NAME = | |

IF_ESA_SAMPLE_PRODUCT=>CO_BO_NODE-WEB_RESOURCE

If the checks at S815 are successful, then it is determined at S820 whether the user is authorized to retrieve any instances of each business object node of the column specifications of the query's SELECT list. The determination may proceed via the following parameters:

| | |
|---|---|
| IF_USER = | <sy-uname> |
| IS_OPERATION-TYPE = | |

IF_RBAM_ESF_CONSTANTS=>CO_OP_TYPE_PATTERN

IS_OPERATION-PNAME =

IF_RBAM_ESF_CONSTANTS=>CO_OP_PNAME_PATTERN_RETRIEVE

| | |
|---|---|
| IF_BO_NAME = | <proxy name of leaf business object> |
| IF_BO_NODE-NAME = | <proxy name of leaf business object |
| node> | |

If the same business object node occurs more than once as a leaf in column specifications of the SELECT list, the authorization check of S820 is performed only once with respect to the business object node.

The following query will be considered to provide an example of S820 according to some embodiments,

| SELECT | PR~ID | AS PRODUCT |
|---|---|---|
| | PR~>Description~Description-languageCode | AS LANGU |
| | PR~>Description~Description-content | AS DESCR |
| FROM http://sap.com/xi/ESF/Product.Root | | AS PR |
| WHERE | PR~>Description~Description-languageCode = | ‘EN’ |

The above SELECT list results in two authorization checks at S820. The first column specification in the select list, PR˜ID AS PRODUCT, will result in an authorization check to verify whether the user is allowed to retrieve any Product˜>Root business object nodes. This authorization check may proceed using the parameters:

| | |
|---|---|
| IF_USER = | <sy-uname> |
| IS_OPERATION-TYPE = | IF RBAM_ESF CONSTANTS=> |

CO_OP_TYPE_PATTERN

IS_OPERATION-PNAME =

IF RBAM_ESF CONSTANTS =>CO_OP_PNAME_PATTERN_RETRIEVE

| | |
|---|---|
| IF_BO_NAME = | IF ESA_SAMPLE_PRODUCT=>CO_BO_NAME |
| IF_BO_NODE_NAME = | IF_ESA_SAMPLE_PRODUCT-CO_BO_NODE-ROOT |

The second column specification in the SELECT list, PR˜>Description-DescriptionlanguageCode AS LANGU will result in an authorization check to verify whether the user is allowed to retrieve any Product˜>Description business object nodes.

| | |
|---|---|
| IF_USER = | <sy-uname> |
| IS_OPERATION-TYPE = | IF RBAM_ESF CONSTANTS=> |

CO_OP_TYPE_PATTERN

IS_OPERATION-PNAME =

IF RBAM_ESF CONSTANTS =>CO_OP_PNAME_PATTERN_RETRIEVE

| | |
|---|---|
| IF_BO_NAME = | IF ESA_SAMPLE_PRODUCT=>CO_BO_NAME |
| IF_BO_NODE_NAME = | IF_ESA_SAMPLE_PRODUCT-CO_BO_NODE- |
| DESCRIPTION | |

The third column specification in the SELECT list, PR˜>Description-Description-content AS DESCR, refers again to the Product˜>Description node. Since authorizations for this node have already been checked in the previous step, the authorization check need not be performed again.

Flow continues from S820 to S825 if the determination at S820 is affirmative. At S825, and for each suitable aggregation specification of the SELECT list, the user's restrictions to retrieve instances of the aggregation specification's business object node are determined. According to some embodiments, “suitable” aggregation specifications are all those other than COUNT.

S825 is performed because the user should be authorized to aggregate values only of business object node instances which the user would also be allowed to retrieve. This rule is based on the fact that all aggregation functions supported by BQL, other than COUNT, can also be used to retrieve the actual value of attributes, and not just an aggregated value. This retrieval may be achieved by specifying a WHERE condition which will match exactly one business object node instance. In this case, the result of the aggregation functions MAX, MIN, AVG or SUM for an attribute of this business object node instance will be identical to the actual value of the attribute. Consequently, authorization to get the result of these aggregation functions for an attribute is, from a security point of view, equivalent to authorization to retrieve the actual value of the attribute.

The following query will be assumed to provide an example of S825 according to some embodiments:

SELECT MAX ( SO~GrossAmount-content )

AS MAX_ORDER_GROSS

MAX ( SO~>Item~GrossAmount-content )

AS MAX_ITEM_GROSS

FROM http://sap.com/xi/ESF/SalesOrder.Root

AS SO

For the aggregation specifications in the above SELECT list, a Restrictions API of business object node access runtime 119 is invoked to retrieve the user's restrictions to RETRIEVE instances of SalesOrder˜>Root. The Restrictions API is then invoked to retrieve the user's restrictions to RETRIEVE instances of SalesOrder˜>Item.

The foregoing query provides an example of aggregation on a secondary business object:

SELECT SO~ID

AS SO_ID

MAX ( SO~>Item~>Product~GrossWeightMeasure-content )

AS MAX_WEIGHT

SO~>Item~~>Product~GrossWeightMeasure-unitCode )

AS WEIGHT_UNIT

FROM http://sap.com/xi/ESF/SalesOrder.Root

AS SO

GROUP BY SO_ID WEIGHT_UNIT

The aggregation specification in the select list of this query (aliased as “WEIGHT UNIT”) refers to a secondary business object, i.e. to a business object other than the one in the FROM clause. More specifically, the aggregation refers to Product˜>Root, while the FROM clause refers to SalesOrder˜>Root.

In the above case, S825 will comprise determining whether the user is authorized to retrieve all instances of Product˜>Root, by obtaining the user's restrictions to retrieve Product˜>Root instances, and then by verifying that these restrictions allow access to all Product˜>Root instances that could potentially exist, no matter what ACL entries are associated with the instances.

Next, at S830, the user's restrictions to RETRIEVE instances of the business object node of the query's FROM clause are determined. According to some embodiments, the Restrictions API of runtime 119 may be called at S830 with the following parameters:

| | |
|---|---|
| IF_USER = | <sy-uname> |
| IS_OPERATION-TYPE = | IF_RBAM_ESF_CONSTANTS=> |

CO_OP_TYPE_PATTERN

| | |
|---|---|
| IS_OPERATION-PNAME = | IF_RBAM_ESF_CONSTANTS=> |

CO_OP_PNAME_PATTERN_RETRIEVE

| | |
|---|---|
| IF_BO_NAME = | <proxy name of FROM clause BO> |
| IF_BO_NODE_NAME = | <proxy name of FROM clause BO node> |
| IF_ACCESS_CONTEXT = | <initial> |

According to some embodiments, S830 further includes determining whether the user is authorized for all, some, or no instances of the FROM clause business object node. Semantically, the user's restriction returned by the previous API call takes special values for “all instances allowed” and “no instances allowed”. These special values can simply be tested, without any need to retrieve business object node data. If the user's restriction is anything other than these two special values, the restriction must be “some instances allowed”.

If the user is authorized for no instances of the FROM clause business object, query execution is aborted as described above. If the user is authorized for all instances of the FROM clause BO, no restrictions are determined at S830.

If the user is authorized for some instances of the FROM clause business object, these restrictions are logically combined at S835 with any user restrictions determined at S825. The Boolean logic behind this combination is conjunction (AND) for grant restrictions, and disjunction (OR) for deny restrictions.

This type of combination is performed because users can be associated with different instance restrictions for different nodes of the FROM business object. For example, a user could be authorized for FROM business object root instances from Germany and U.S., but for FROM business object items from Germany only. Consequently, performing the query with restrictions for the root node only (Germany and U.S.) would result in aggregating item data that the user is not authorized to retrieve (U.S.).

A WHERE clause is generated at S840 based on the combined user's restrictions. According to some embodiments, a transformation rule from node access restrictions into an SQL-style WHERE clause requires parentheses, AND combination, OR combination, negation (NOT), and comparison using the =(equal), <_ (less than or equal) and >_ (greater than or equal) operators.

The following is an example of an ABAP OpenSQL WHERE clause including node access restrictions:

WHERE

( ″start of all grant restrictions

e~start validity <= sy-datum
AND e~end validity >= sy-datum
AND

( ″start of grant restrictions for access context

ACCI e~context - ′ACC1′
OR

( ″start of grant restrictions for access context

ACC2 e~context = ′ACC2′

AND e~delegate IN (′UUID3′, ′UUID4′)

)
)

)

AND NOT

( ″start of all deny restrictions
e~start_ validity c= sy-datum
AND e~end validity >= sy-datum
AND

( ″start of deny restrictions for access context ACC1
e~context = ′ACC1′
AND e~delegate IN (′UUID1′, ′UUID2′)
)

OR

( ″start of deny restrictions access context ACC2
e~context = ′ACC2′
AND e~delegate IN (′UUID3′)
)

OR

( ″start of deny restrictions for access context ACC3
e~context = ′ACC3′
)

) . ″end of all deny restrictions.

Returning to process 800, the received query, including the generated WHERE clause, is executed at S845. Search service runtime 117 may execute the query using generated load 116 and an appropriate one of search plugins 118 as is known in the art. Consequently, an intermediate result set is obtained.

At S850, it is determined whether the user is authorized to RETRIEVE instances of all leaf business object nodes of the WHERE clause whose node IDs are contained in the intermediate result set. The node IDs of all WHERE clause leaf business object nodes were previously obtained at S240 of process 200.

From a security point of view, authorization to evaluate arbitrary WHERE clauses for all attributes of a business object node instance is equivalent to authorization to retrieve the actual values of all attributes of this business object node instance. Therefore, evaluating a WHERE condition for a business object node instance requires authorization to retrieve the data of this business object node instance.

The following parameters may be used during the determination at S850:

| | |
|---|---|
| IF_USER = | <sy-uname> |
| IS_OPERATION-TYPE = | IF_RBAM_ESF_CONSTANTS=> |

CO_OP_TYPE_PATTERN

| | |
|---|---|
| IS_OPERATION-PNAME = | IF_RBAM_ESF_CONSTANTS=> |

CO_OP_PNAME_PATTERN_RETRIEVE

| | |
|---|---|
| IF_BO_NAME = | <proxy name of WHERE clause BO> |
| IF_BO_NODE_NAME = | <proxy name of WHERE clause BO |
| | node> |

IT_BO_NODE_IDS = <list of WHERE clause leaf BO node IDs>

Query execution is aborted if any of the authorization checks at S850 fails. According to some embodiments, the result set is dismissed completely, rather than clearing the cells containing data of business object node identifiers for which the user does not possess retrieve authorizations. An example of S850 will be provided under the assumption that the following query was executed at S845:

SELECT SO~ID AS SO_ID
FROM http://sap.com/xi/ESF/SalesOrder.Root AS SO
WHERE SO~>BuyerParty~Root-ID = ′1′

For the WHERE clause in the example above, the attribute “NODE_ID” of BusinessPartner˜>Root will have been previously requested, because BusinessPartner˜>Root is the leaf business object of the WHERE clause. For clarity, this row of the result set will have the name “BUPA_NODE_ID” in the following result set example. Any additional attributes which will be implicitly requested due to other requirements will be ignored in this example. Using these assumptions, the result set may look like:

| ID | BUPA_NODE_ID |
|---|---|
| 5000000004 | 4711 |
| 5000000005 | 0815 |

This intermediate result set will result in the following instance authorization check at S850, to verify that the user is allowed to retrieve the data of all Business Partner˜>Root instances that matched the WHERE condition. The node IDs of these instances are 4711 and 0815 in the example.

| | |
|---|---|
| IF_USER = | <sy-uname> |
| IS_OPERATION-TYPE = | IF_RBAM_ESF_CONSTANTS=> |

CO_OP_TYPE_PATTERN

| | |
|---|---|
| IS_OPERATION-PNAME = | IF_RBAM_ESF_CONSTANTS=> |

CO_OP_PNAME_PATTERN_RETRIEVE

IF_BO_NAME =

IF_ ESA_SAMPLE_BUSINESS_PARTNER=>CO_BO_NAME

IF_BO_NODE_NAME =

IF_ESA_SAMPLE_BUSINESS_PARTNER=>CO_BO_NODE-ROOT

| | |
|---|---|
| IT_BO_NODE_IDS = | { 4711, 0815 } |

Next, at S855, it is determined whether the user is authorized to RETRIEVE instances of all leaf business object nodes in column specifications of the SELECT list and whose node IDs are contained in the intermediate result set. This check is performed because the user performing the query will effectively retrieve data of instances of the leaf business object nodes used in column specifications of the SELECT list.

The following parameters may be used at S855:

| | |
|---|---|
| IF_USER = | <sy-uname> |
| IS_OPERATION-TYPE = | IF_RBAM_ESF_CONSTANTS=> |

CO_OP_TYPE_PATTERN

| | |
|---|---|
| IS_OPERATION-PNAME = | IF_RBAM_ESF_CONSTANTS=> |

CO_OP_PNAME_PATTERN_RETRIEVE

IF_BO_NAME =

<proxy name of leaf BO in SELECT list column spec>

IF_BO_NODE_NAME =

<proxy name of leaf BO in SELECT list column spec>

IT_BO_NODE_IDS =

<list of SELECT list column spec leaf BO node IDs>

As an example of S855 according to some embodiments, the following query is considered:

SELECT SO~ID AS SO_ID
FROM http://sap.com/xi/ESF/SalesOrder.Root AS SO

For the SELECT list in the example above, the attribute “NODE_ID” of SalesOrder˜>Root would be implicitly requested to be returned in the intermediate result set provided by the search plugin. This attribute is called “SO_NODE_ID” in the following example result set:

| SO_ID | SO_NODE_ID |
|---|---|
| 5000000000 | ABCDEF00 |
| 5000000004 | ABCDEF04 |
| 5000000005 | ABCDEF05 |

Based on these node IDs, the following instance authorization check would be performed at S855 to verify that the user is allowed to retrieve all SalesOrder˜>Root instances whose attribute “ID” is returned in the intermediate result set:

| | |
|---|---|
| IF_USER = | <sy-uname> |
| IS_OPERATION-TYPE = | IF_RBAM_ESF_CONSTANTS=> |

CO_OP_TYPE_PATTERN

| | |
|---|---|
| IS_OPERATION-PNAME = | IF_RBAM_ESF_CONSTANTS=> |

CO_OP_PNAME_PATTERN_RETRIEVE

IF_BO_NAME =

IF_ ESA_SAMPLE_SALES_ORDER=>CO_BO_NAME

IF_BO_NODE_NAME =

IF_ESA_SAMPLE_SALES_ORDER=>CO_BO_NODE-ROOT

| | |
|---|---|
| IT_BO_NODE_IDS = | { ABCDEF00, ABCDEF05, |
| | ABCDEF05 } |

If no authorization checks at S855 fail, the current result set is returned to the user at S865. For each authorization check which fails at S855, and in which the business object node for which the check was performed was the business object node given in the FROM clause, the corresponding row is removed from the result set at S860. The resulting final result set is returned to the user at S865, along with one authorization error message for each failed check.

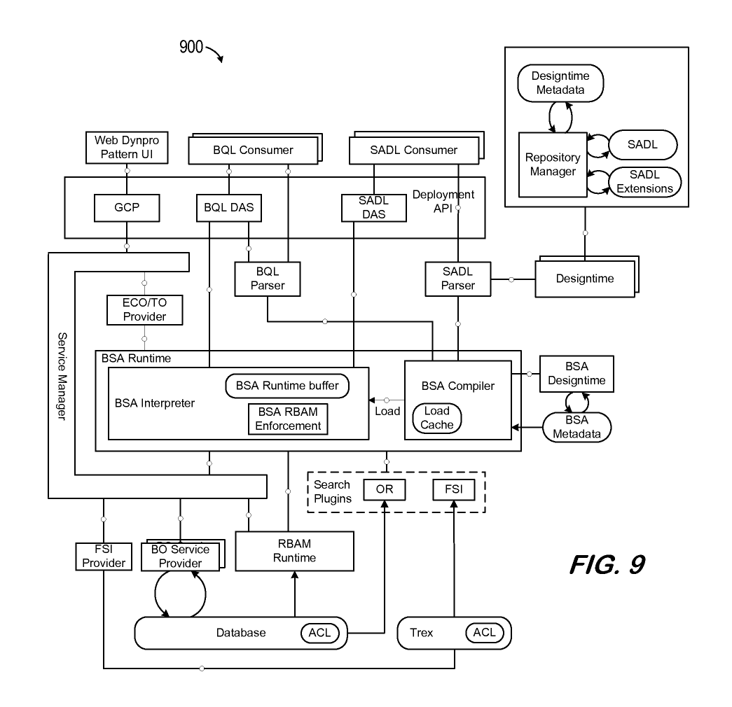

FIG. 9 is a detailed block diagram of architecture 900 that may implement process 200 and/or process 800 according to some embodiments. Generally, architecture 900 provides for execution of free searches on business object nodes. Such searches may be defined in BQL or SADL according to the illustrated implementation.

SADL is an XML-based language to describe a mapping between a data structure and attributes of Business Object nodes via XPath-like expressions. In case that a query is defined via an SADL source, the SADL source is passed to the BSA runtime via the SADL Parser. The SADL Parser then checks the syntax and translates the source into a language-independent format suitable for the BSA Compiler. The SADL Parser may also provide an interface to validate the syntax of the SADL source.

The BQL Parser is used to translate a received BQL statement to the compiler format. The BQL Parser also provides an interface to validate the syntax of the BQL statement.

The BSA Compiler is to provide an interface for passing metadata to the runtime. The BSA Compiler receives a query in language-independent format and compiles the query into a load in an optimized format for the runtime. The runtime load is cached to provide fast access at runtime.

During compilation, the BSA Compiler determines a strategy to fulfill the user request. The Search Plugins are called during this determination, and the strategy is stored as part of the runtime load. The FSI search plugin analyses whether a FSI view exists that can be used for executing the user request. The OR plugin analyzes the database tables where the business object data is stored.

The BQL Data Access Services and the SADL Data Access Services provide an entry point to consume the architecture. Both Data Access Services call the BSA Interpreter with the object key of a runtime load to provide the requested data. The BSA Interpreter retrieves the runtime load from the BSA Compiler and executes the necessary operations. This execution can be performed via either search plugin, depending on the execution strategy determined during compilation.

The BSA Interpreter includes Business Object Node Access Management Enforcement point to access services provided by the RBAM Runtime. These services may include services to determine authorizations and restrictions associated with business object nodes as described above.

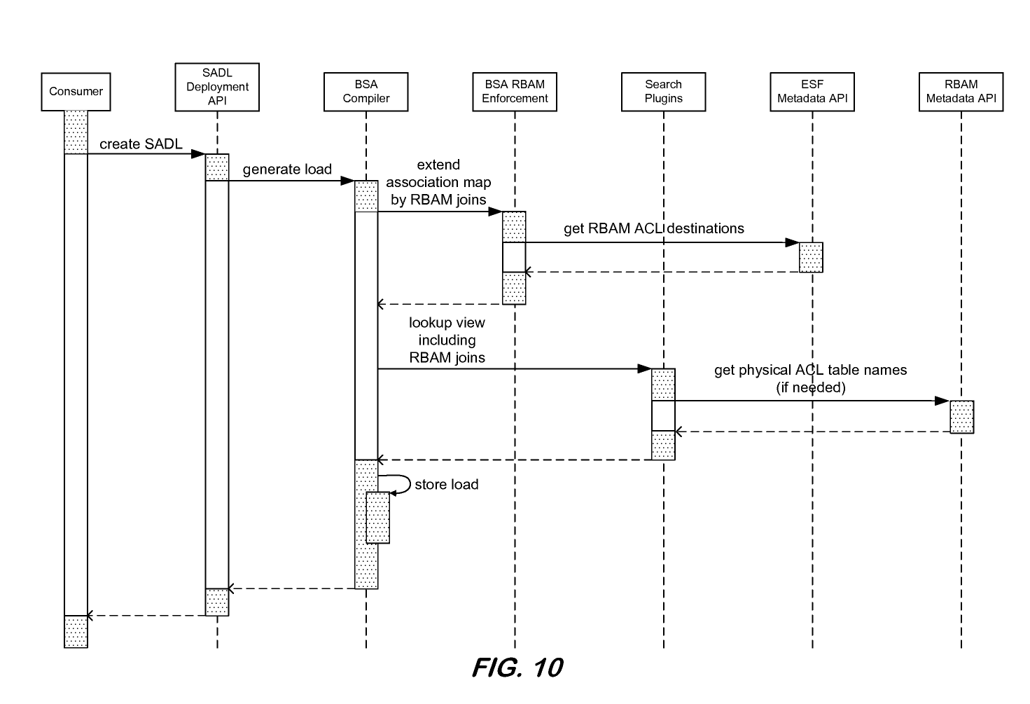

FIG. 10 is a sequence diagram illustrating execution of process 200 by architecture 900 according to some embodiments. As shown, a Consumer passes an SADL source created by a developer to the SADL deployment API for creation of a query based thereon. The query is parsed by the SADL parser (not shown in FIG. 10) and sent to the BSA Compiler, where it is received at S210. In order to generate a load associated with the query, the BSA Compiler generates an association map at S220. Next, the Business Object Node Access Management Enforcement point calls an Enterprise Service Framework metadata API provided by the Service Manager of architecture 900 to retrieve the metadata of ACL entries and node IDs at S230, S240 and S250.

The Business Object Node Access Management Enforcement point then extends the association map based on the retrieved information and passes the extended association map to the BSA Compiler. Using known techniques, the BSA Compiler interacts with one or more of the Search Plugins at S260 to look up a view for query execution based on the extended association map, and to store the view in a load.

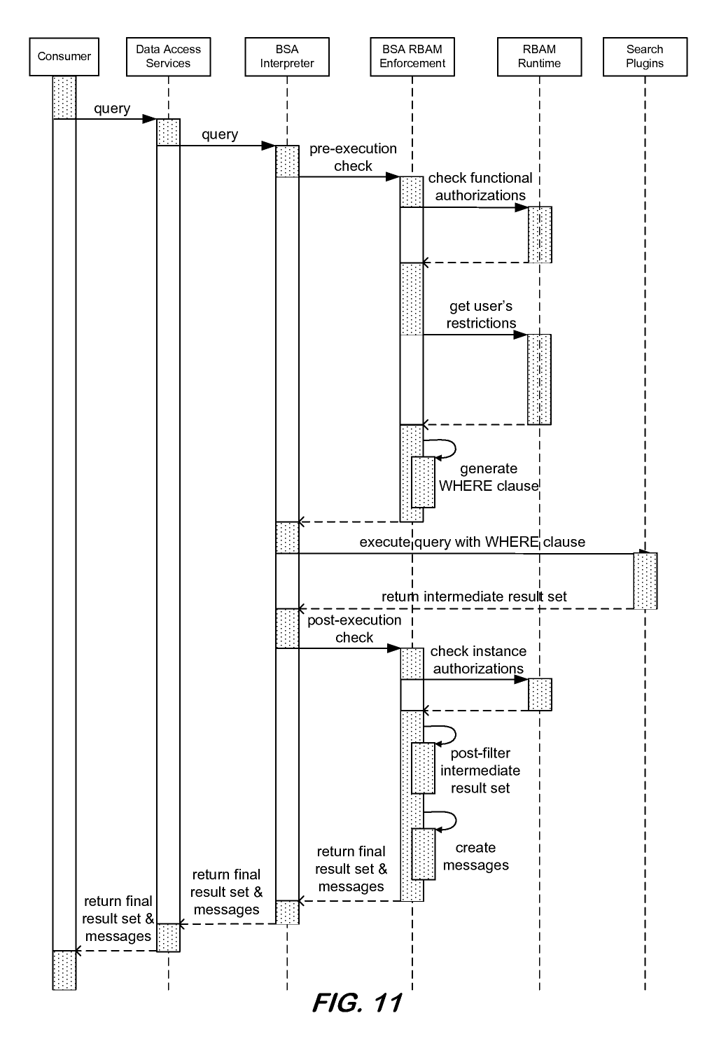

FIG. 11 is a sequence diagram illustrating execution of process 800 by architecture 900 according to some embodiments. A user's query is initially received by Data Access Services from a corresponding Consumer at S805, and is then received by the BSA Interpreter. The BSA Interpreter instructs the Business Object Node Access Management Enforcement point to perform pre-execution authorization checks.

The Business Object Node Access Management Enforcement point invokes services provided by the RBAM Runtime to check authorizations as described with respect to S810 through S820. Next, the Business Object Node Access Management Enforcement point invokes services provided by the RBAM Runtime to determine the user's restrictions as described with respect to S825 and S830. The Business Object Node Access Management Enforcement point combines the determined restrictions at S835 and generates a corresponding WHERE clause at S840.

The BSA Interpreter instructs the Search Plugins to execute the received query with the WHERE clause at S845, and obtains an intermediate result set therefrom. The Business Object Node Access Management Enforcement point again invokes services of the RBAM Runtime to perform instance authorization checks as described with respect to S850 and S855. Finally, the Business Object Node Access Management Enforcement point filters the intermediate result set at S860 and returns the final result set to the user via the BSA Interpreter, the Data Access Services, and the Consumer.

Each system described herein may be implemented by any number of devices in communication via any number of other public and/or private networks. Two or more of devices of may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, a Zip™ disk, magnetic tape, and solid state RAM or ROM memories. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A method comprising:
receiving a query from a user to retrieve data from a first business object node of a business object, the business object representing stored data;
determining whether the user is authorized to traverse all associations of a SELECT list of the query;
determining whether the user is authorized to traverse all associations of a WHERE clause of the query;
determining whether the user is authorized to retrieve any instances of each business object node of column specifications of the SELECT list of the query; and
if the determinations are affirmative, executing the query to retrieve a first result set.

2. A method according to claim 1, further comprising:
determining first restrictions of the user to retrieve instances of the first business object node,
wherein the query is executed with the first restrictions.

3. A method according to claim 2, wherein executing the query with the first restrictions comprises generating a WHERE clause conforming to a query language based on the first restrictions, the method further comprising:
determining second restrictions of the user to retrieve instances of a business object node of an aggregation specification of the SELECT list of the query; and
logically combining the first restrictions and the second restrictions,
wherein generating the WHERE clause comprises generating the WHERE clause based on the logically-combined first restrictions and second restrictions.

4. A method according to claim 1, further comprising:
determining whether the user is authorized to retrieve instances of business object nodes associated with node identifiers of the first result set.

5. A method according to claim 4, wherein, if it determined that the user is authorized to retrieve instances of business object nodes associated with one or more node identifiers of the first result set, the method further comprises:
if the one or more node identifiers are associated with the business object of a FROM clause of the query, clearing cells of the first result set corresponding to the one or more node identifiers.

6. A method according to claim 1, further comprising:
aborting execution of the query if it is determined that the user is not authorized to retrieve instances of business object nodes associated with one or more node identifiers of the first result set.

7. A computer-readable medium storing program code executable by a computer to:
receive a query from a user to retrieve data from a first business object node of a business object, the business object representing stored data;
determine whether the user is authorized to traverse all associations of a SELECT list of the query;
determine whether the user is authorized to traverse all associations of a WHERE clause of the query;
determine whether the user is authorized to retrieve any instances of each business object node of column specifications of the SELECT list of the query; and
if the determinations are affirmative, execute the query to retrieve a first result set.

8. A medium according to claim 7, the program code further executable by a computer to:
determine first restrictions of the user to retrieve instances of the first business object node,
wherein the query is executed with the first restrictions.

9. A medium according to claim 8, wherein execution of the query with the first restrictions comprises generating a WHERE clause conforming to a query language based on the first restrictions, the program code further executable by a computer to:
determine second restrictions of the user to retrieve instances of a business object node of an aggregation specification of the SELECT list of the query; and
logically combine the first restrictions and the second restrictions,
wherein generation of the WHERE clause comprises generation of the WHERE clause based on the logically-combined first restrictions and second restrictions.

10. A medium according to claim 7, the program code further executable by a computer to:
determine whether the user is authorized to retrieve instances of business object nodes associated with node identifiers of the first result set.

11. A medium according to claim 10, wherein, if it determined that the user is authorized to retrieve instances of business object nodes associated with one or more node identifiers of the first result set, the program code is further executable by a computer to:
clear cells of the first result set corresponding to the one or more node identifiers if the one or more node identifiers are associated with the business object of a FROM clause of the query.

12. A medium according to claim 7, the program code further executable by a computer to:
abort execution of the query if it is determined that the user is not authorized to retrieve instances of business object nodes associated with one or more node identifiers of the first result set.

13. A system comprising:
a data source comprising stored data; and
a business process platform including business object metadata defining business objects representing the stored data, the business process platform to:
receive a query from a user to retrieve data from a first business object node of a business object, the business object representing stored data;
determine whether the user is authorized to traverse all associations of a SELECT list of the query;
determine whether the user is authorized to traverse all associations of a WHERE clause of the query;
determine whether the user is authorized to retrieve any instances of each business object node of column specifications of the SELECT list of the query; and
if the determinations are affirmative, executing the query to retrieve a first result set.

14. A system according to claim 13, the business process platform further to:
determine first restrictions of the user to retrieve instances of the first business object node,
wherein the query is executed with the first restrictions.

15. A system according to claim 14, wherein execution of the query with the first restrictions comprises generating a WHERE clause conforming to a query language based on the first restrictions, the business process platform further to:
determine second restrictions of the user to retrieve instances of a business object node of an aggregation specification of the SELECT list of the query; and
logically combine the first restrictions and the second restrictions,
wherein generation of the WHERE clause comprises generation of the WHERE clause based on the logically-combined first restrictions and second restrictions.

16. A system according to claim 13, the business process platform further to:
determine whether the user is authorized to retrieve instances of business object nodes associated with node identifiers of the first result set.

17. A system according to claim 16, wherein, if it determined that the user is authorized to retrieve instances of business object nodes associated with one or more node identifiers of the first result set, the business process platform further to:
if the one or more node identifiers are associated with the business object of a FROM clause of the query, clear cells of the first result set corresponding to the one or more node identifiers.

18. A system according to claim 13, the business process platform further to:
abort execution of the query if it is determined that the user is not authorized to retrieve instances of business object nodes associated with one or more node identifiers of the first result set.
